(19) United States
(12) Patent Application Publication
(10) Pub. No.: US 2007/0063762 A1
(43) Pub. Date: Mar. 22, 2007

(54) Semiconductor device with charge pump booster circuit

(76) Inventors: Kenji Yoshida, Chiba-shi (JP); Tooru Sudou, Chiba-shi (JP); Sung Hwi Park, Anyang-si (KR)

Correspondence Address: BRINKS HOFER GILSON & LIONE, P.O. BOX 10395, CHICAGO, IL, 60610, US

(21) Appl. No.: 11/521,675

(22) Filed: Sep. 14, 2006

(30) Foreign Application Priority Data
Sep. 20, 2005 (JP) JP2005-271466

(51) Int. Cl. G05F 1/10

(52) U.S. Cl. 327/536

(57) ABSTRACT

Provided is a charge pump booster circuit capable of outputting desired boosted voltage that is not limited to an integral multiple of input voltage and further outputting stable boosted voltage even if a load fluctuates. In the charge pump booster circuit, gate voltage of a transistor for pumping is controlled according to voltage, which is a feedback of boosted voltage, to control the boosted voltage.

This application claims priority under 35 U.S.C. § 119 to Japanese Patent Application No. JP2005-271466 filed Sep. 20, 2005, the entire content of which is hereby incorporated by reference.

### BACKGROUND

1. Field of the Invention

The present invention relates to a semiconductor device having a charge pump booster circuit using a capacitor and switch means.

2. Description of the Related Art

A semiconductor device having a booster circuit generates, for example, drive voltage of 3 V for a liquid crystal display device boosted from a dry battery of 1.5 V as a power supply. As such a booster circuit, a charge pump booster circuit which boosts voltage by switching between series connection and parallel connection of capacitors (for example, see JP 2004-23832 A).

FIG. 6 illustrates a conventional charge pump booster circuit. A drain of a transistor 22 is connected to an input terminal 21 while a source of the transistor 22 is connected to one terminal of a pumping capacitor 24. A drain of a transistor 23 is connected to the input terminal 21 while a source of the transistor 23 is connected to the other terminal of the pumping capacitor 24. A drain of a transistor 25 is connected to the other terminal of the pumping capacitor 24 while a source of the transistor 25 is grounded. A drain of a transistor 26 is connected to the one terminal of the pumping capacitor 24 while a source of the transistor 26 is connected to one terminal of an output capacitor 27. The one terminal of the output capacitor 27 is connected to an output terminal 28 while the other terminal of the output capacitor 27 is grounded.

In the charge pump booster circuit of the above-mentioned structure, the transistors 22 and 25 are turned on to charge the pumping capacitor 24 with voltage inputted to the input terminal 21, and the transistors 23 and 26 are turned on to pump up the voltage of the pumping capacitor 24 to charge the output capacitor 27 with the voltage, and thus, boosted voltage can be outputted to the output terminal 28. When the charge pump booster circuit has two stages as illustrated in FIG. 6, voltage twice as high as the input voltage can be obtained.

However, in the above-mentioned conventional charge pump booster circuit, the boosted voltage is limited to an integral multiple of the input voltage, and it is therefore difficult to obtain desired voltage. For example, in a conventional two-stage charge pump booster circuit, the input voltage is 3 V while the boosted voltage is 6 V. Therefore, a semiconductor device, the maximum voltage rating of which is 5 V, can not be used with power supply voltage of 4.5 V.

Further, because the design is conducted such that, even if a maximum load is connected, output voltage drop is within a tolerance, it is necessary to make larger the capacitance of the capacitors in use or to make higher the frequency of a clock signal for boosting. However, to make larger the capacitance of the capacitors is not appropriate for miniaturization required for a personal digital assistant or the like, and also increases the cost. To make higher the frequency of a clock signal for boosting makes larger the current consumption, which results in reduced voltage conversion efficiency.

Further, when a load which consumes current in a pulse-like manner is connected, there is a problem that output voltage fluctuations become larger.

### SUMMARY OF THE INVENTION

The present invention is made to solve the above-mentioned problems. An object of the present invention is to provide a charge pump booster circuit which can obtain arbitrary boosted voltage and which can output stable boosted voltage even if the load fluctuates.

According to an aspect of the present invention, a charge pump booster circuit is structured such that the impedance of a boost switch for controlling boost operation is controlled according to boosted voltage to obtain desired boosted voltage.

Further, the charge pump booster circuit is provided with two booster circuits each including a boost capacitor and boost switches. By shifting the timing of the respective boost operations with each other, the charge pump booster circuit is structured such that the charge pump booster circuit can output more stable boosted voltage even if the load fluctuates.

The above-mentioned charge pump booster circuit according to the present invention can obtain desired boosted voltage which is not an integral multiple of the input voltage.

Further, the charge pump booster circuit can output stable voltage even if the load fluctuates without making larger the capacitance of boost capacitors and without making higher the frequency of a clock signal for boosting.

### BRIEF DESCRIPTION OF THE DRAWINGS

In the accompanying drawings:

FIG. 1 is a block diagram of a charge pump booster circuit according to a first embodiment of the present invention;

FIG. 2 is a circuit diagram illustrating an example of a boost clock control circuit of the charge pump booster circuit according to the first embodiment of the present invention;

FIG. 3 is a timing chart of the charge pump booster circuit according to the first embodiment of the present invention;

FIG. 4 is a block diagram of charge pump booster circuits according to a second embodiment of the present invention;

FIG. 5 is a timing chart of the charge pump booster circuits according to the second embodiment of the present invention; and

FIG. 6 is a circuit diagram of a conventional charge pump booster circuit.

### DETAILED DESCRIPTION OF THE PREFERRED EMBODIMENTS

### First Embodiment

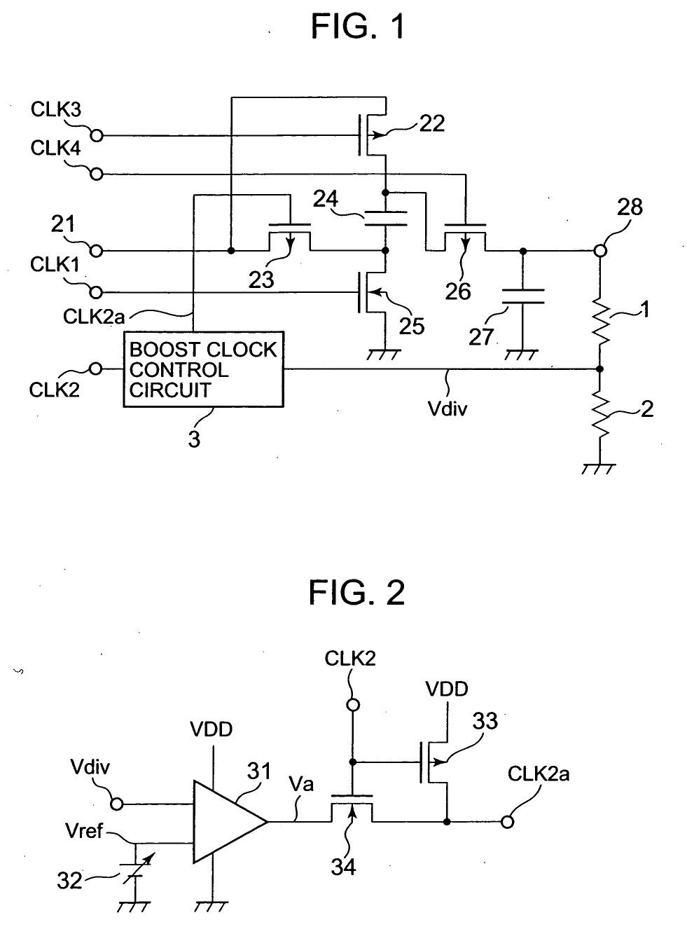

FIG. 1 is a block diagram illustrating a charge pump booster circuit according to a first embodiment of the present invention. In the charge pump booster circuit according to the first embodiment, a drain of a transistor 22 is connected to an input terminal 21 while a source of the transistor 22 is connected to one terminal of a pumping capacitor 24. A drain of a transistor 23 is connected to the input terminal 21 while a source of the transistor 23 is connected to the other terminal of the pumping capacitor 24. A drain of a transistor 25 is connected to the other terminal of the pumping capacitor 24 while a source of the transistor 25 is grounded. A drain of a transistor 26 is connected to the one terminal of the pumping capacitor 24 while a source of the transistor 26 is connected to one terminal of an output capacitor 27. The one terminal of the output capacitor 27 is connected to an output terminal 28 while the other terminal of the output capacitor 27 is grounded. CLK3, CLK1, and CLK4 are inputted to a gate of the transistor 22, a gate of the transistor 25, and a gate of the transistor 26, respectively.

Further, the charge pump booster circuit is provided with voltage dividing resistances 1 and 2 for outputting divided voltage Vdiv of the output terminal 28 and a boost clock control circuit 3 to which the divided voltage Vdiv and CLK2 are inputted and which outputs CLK2a adjusted according to the value of the divided voltage Vdiv. CLK2a is inputted to a gate of the transistor 23.

In the charge pump booster circuit structured as described above, the pumping capacitor 24 is charged with voltage inputted to the input terminal 21. By boosting the voltage and charging the output capacitor 27 with the boosted voltage, the boosted voltage can be outputted to the output terminal 28. Here, the boost clock control circuit 3 adjusts CLK2 to be CLK2a according to the value of the divided voltage Vdiv. In other words, the gate of the transistor 23 can be feedback controlled according to the value of the output voltage. Therefore, voltage with which the output capacitor 27 is charged by the pumping capacitor 24 can be adjusted to obtain desired boosted voltage.

FIG. 2 is a circuit diagram illustrating an example of the boost clock control circuit 3 of the charge pump booster circuit according to the first embodiment of the present invention. The boost clock control circuit 3 includes an amplifier 31, to which the divided voltage Vdiv and reference voltage Vref outputted by a reference voltage circuit 32 are inputted and which outputs voltage Va for setting a peak value of CLK2a, and transistors 33 and 34 for amplification conversion of inputted CLK2 into VDD and Va, respectively.

Operation of the charge pump booster circuit is the same as that of a conventional charge pump booster circuit until the pumping capacitor 24 is charged with the voltage inputted to the input terminal 21. When the output capacitor 27 is charged with the voltage with which the pumping capacitor 24 is charged, the output of the amplifier 31 is controlled according to the value of the output voltage which is fed back as the divided voltage Vdiv, and thus the peak value when CLK2a is at a low level is controlled. Therefore, the voltage of the output capacitor 27 can be controlled.

The output voltage is expressed by the following Equation 1:
Vout=Vred×(R1+R2)/R2 (Equation 1)
where the resistance of the voltage dividing resistance 1 is R1 Ω, the resistance of the voltage dividing resistance 2 is R2 Ω, and the output voltage is Vout.

In other words, the reference voltage Vref is made to be variable, so the voltage with which the output capacitor 27 is charged can be controlled to be desired voltage which is up to twice as high as the voltage inputted to the input terminal 21.

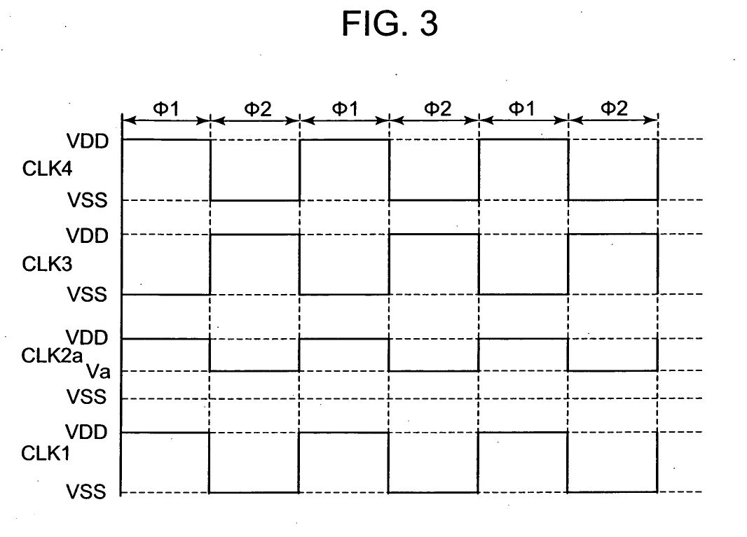

FIG. 3 is a timing chart of the charge pump booster circuit according to the first embodiment of the present invention. Voltage VDD is inputted to the input terminal 21. The amplitude of the clock signals CLK1, CLK3, and CLK4 is VDD−VSS. The amplitude of CLK2a is VDD−Va, where the voltage Va outputted by the amplifier 31 is in accordance with the relationship between the output voltage Vout and the reference voltage Vref.

First, during a period Φ1, since the clock signals CLK1, CLK2a, and CLK4 are at VDD and the clock signal CLK3 is at VSS, the transistors 22 and 25 are on while the transistors 23 and 26 are off. Therefore, the terminals of the pumping capacitor 24 are connected to VDD and VSS, respectively, and electric charge is charged. Next, during a period Φ2, since the clock signals CLK1 and CLK4 are at VSS and the clock signal CLK3 is at VDD, the transistors 22 and 25 are off while the transistor 26 is on. The clock signal CLK2a is at a low level, and the output capacitor 27 is charged via the transistor 26 with voltage which is pumped up from the potential on the side of VSS of the pumping capacitor 24. Since the potential of the clock signal CLK2a is controlled by the output Va of the amplifier 31, the pumped voltage is controlled by the impedance of the transistor 23. In other words, the output voltage Vout is controlled as expressed by Equation 1 in relation to the set reference voltage Vref. By repeating the operation, the boost operation is carried out.

When the output voltage is lowered due to load fluctuations, the fact is fed back to the boost clock control circuit 3 as the divided voltage Vdiv. Then, the output voltage Va of the amplifier 31 is lowered, the amplitude of the clock signal CLK2a is increased, the pumped voltage is raised, and thus, the desired output voltage can be maintained.

As described above, according to the charge pump booster circuit of the first embodiment of the present invention, not only output voltage corresponding to an integral multiple of the input voltage, but also output voltage other than that can be obtained. Further, since the pumping operation has a margin, fluctuations of the output voltage due to load fluctuations can be prevented.

### Second Embodiment

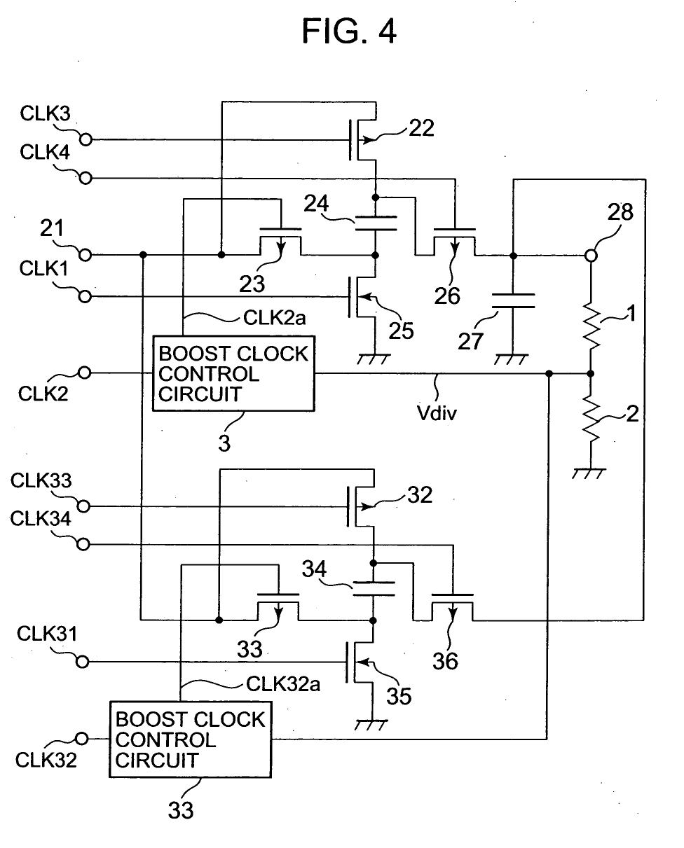

FIG. 4 is a circuit diagram illustrating charge pump booster circuits according to a second embodiment of the present invention. As illustrated in FIG. 4, provided are two charge pump booster circuits which share an input terminal 21, an output terminal 28, voltage dividing resistances 1 and 2, and an output capacitor 27. In FIG. 4, a boost clock control circuit 3 and a boost clock control circuit 33 are separately provided. However, reference voltage Vref may be shared.

Boost operation of the respective circuits is similar to that of the charge pump booster circuit in the first embodiment.

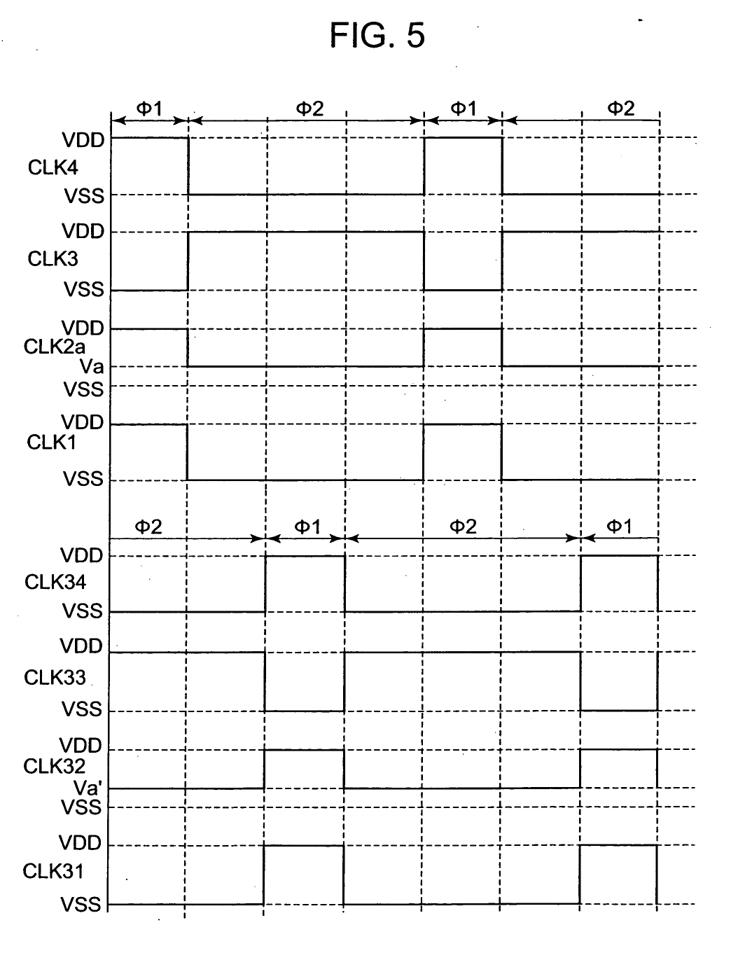

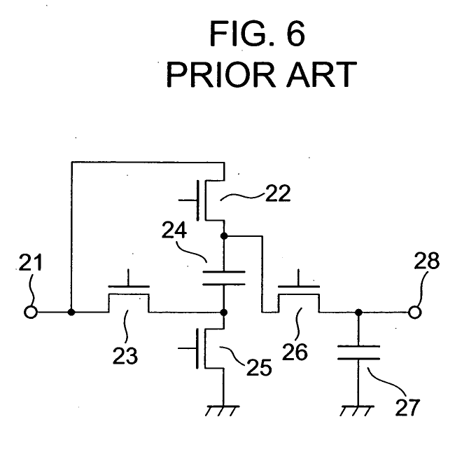

FIG. 5 is a timing chart of the charge pump booster circuits according to the second embodiment of the present invention. Similarly to the case of the first embodiment, voltage VDD is inputted to the input terminal 21 and the amplitude of clock signals CLK1, CLK3, and CLK4 is VDD−VSS while the amplitude of CLK2a is VDD−Va. The amplitude of clock signals CLK31, CLK33, and CLK34 is VDD−VSS while the amplitude of CLK32a is VDD−Va′.

In the first charge pump booster circuit, first, during a period Φ1, since the clock signals CLK1, CLK2a, and CLK4 are at VDD and the clock signal CLK3 is at VSS, the transistors 22 and 25 are on while the transistors 23 and 26 are off. Therefore, the terminals of the pumping capacitor 24 are connected to VDD and VSS, respectively, and electric charge is charged. Next, during a period Φ2, since the clock signals CLK1 and 4 are at VSS and the clock signal CLK3 is at VDD, the transistors 22 and 25 are off while the transistor 26 is on. The clock signal CLK2a is at a low level, and the output capacitor 27 is charged via the transistor 26 with voltage which is pumped up from the potential on the side of VSS of the pumping capacitor 24. Since the potential of the clock signal CLK2a is controlled by the output Va of the amplifier 31, the pumped voltage is controlled by the impedance of the transistor 23. In other words, the output voltage Vout is controlled as expressed by Equation 1 in relation to the set reference voltage Vref.

When the output voltage is lowered due to load fluctuations, the fact is fed back to the boost clock control circuit 3 as the divided voltage Vdiv. However, the matter can not be adequately handled within the period Φ1 for charging the pumping capacitor 24 with electric charge, and the desired output voltage can not be maintained.

Here, the clock signals are set such that the period Φ1 of the first charge pump booster circuit is in the period Φ2 of the second charge pump booster circuit. By operating the two charge pump booster circuits with such clock signals, the periods Φ1 of the two charge pump booster circuits are complemented by each other, output voltage drop due to load fluctuations is prevented, and the desired output voltage can be always maintained.

As described above, according to the charge pump booster circuit of the second embodiment of the present invention, not only output voltage corresponding to an integral multiple of the input voltage, but also output voltage other than that can be obtained. Further, since the pumping operation has a margin, fluctuations of the output voltage due to load fluctuations can be prevented.

What is claimed is:

1. A semiconductor device having a charge pump booster circuit, the charge pump booster circuit comprising:
a plurality of boost capacitors;
a plurality of boost switches; and
a boost clock control circuit for monitoring boosted voltage and controlling impedance of the boost switches.

2. A semiconductor device having a charge pump booster circuit, the charge pump booster circuit comprising:
an input terminal;
an output terminal;
a pumping capacitor to be charged with voltage inputted to the input terminal;
an output capacitor to be charged with boosted voltage from the pumping capacitor;
a plurality of boost switches for controlling boost operation of the pumping capacitor and the output capacitor;
a boost clock input terminal to which a plurality of boost clocks for controlling the boost switches are inputted; and
a boost clock control circuit for controlling a peak value of the boost clocks according to the boosted voltage of the output capacitor outputted to the output terminal.

3. A semiconductor device having a charge pump booster circuit according to claim 2, wherein the boost switches comprise MOS transistors.

4. A semiconductor device having a charge pump booster circuit according to claim 2, wherein the boost clock control circuit comprises:
a reference voltage circuit for outputting reference voltage;
an amplifier for comparing divided voltage obtained by dividing the boosted voltage with the reference voltage; and
a plurality of MOS transistors for controlling a peak value of the boost clocks by output of the amplifier.

5. A semiconductor device having a charge pump booster circuit according to claim 3, wherein the boost clock control circuit controls gate voltage of the MOS transistors for pumping up voltage of the pumping capacitor.

6. A semiconductor device having a charge pump booster circuit according to claim 4, wherein desired boosted voltage is outputted by setting the reference voltage.

7. A semiconductor device having a charge pump booster circuit, the charge pump booster circuit comprising:
an input terminal;
an output terminal;
a first pumping capacitor to be charged with voltage inputted to the input terminal;
a second pumping capacitor to be charged with voltage inputted to the input terminal;
an output capacitor to be charged with boosted voltage from the first and second pumping capacitors;
a first boost switch group for controlling boost operation of the first pumping capacitor and the output capacitor;
a second boost switch group for controlling boost operation of the second pumping capacitor and the output capacitor;
a boost clock input terminal to which a plurality of boost clocks for controlling the first and second boost switch groups are inputted;
a first boost clock control circuit for controlling a peak value of the boost clocks of the first boost switch group according to the boosted voltage of the output capacitor outputted to the output terminal; and
a second boost clock control circuit for controlling a peak value of the boost clocks of the second boost switch group according to the boosted voltage of the output capacitor outputted to the output terminal.

8. A semiconductor device having a charge pump booster circuit according to claim 7, wherein the output capacitor is charged with boosted voltage from the second pumping capacitor when the first pumping capacitor is charged with input voltage and is charged with boosted voltage from the first pumping capacitor when the second pumping capacitor is charged with the input voltage.

9. A semiconductor device having a charge pump booster circuit according to claim 7, wherein the boost switches comprise MOS transistors.

10. A semiconductor device having a charge pump booster circuit according to claim 7, wherein the first and second boost clock control circuits each comprise:
a reference voltage circuit for outputting reference voltage;
an amplifier for comparing divided voltage obtained by dividing the boosted voltage with the reference voltage; and
a plurality of MOS transistors for controlling a peak value of the boost clocks by output of the amplifier.

11. A semiconductor device having a charge pump booster circuit according to claim 8, wherein the first and second boost clock control circuits each control gate voltage of the MOS transistors for pumping up voltage of each of the first and second pumping capacitors.

12. A semiconductor device having a charge pump booster circuit according to claim 10, wherein the first and second boost clock control circuits share a reference voltage circuit.

13. A semiconductor device having a charge pump booster circuit according to claim 10, wherein desired boosted voltage is outputted by setting the reference voltage.
